(19) United States
(12) Patent Application Publication
(10) Pub. No.: US 2025/0357056 A1
(43) Pub. Date: Nov. 20, 2025

(54) Dry Mechanism with Multilayer Coating

(71) Applicants: ABB Schweiz AG, Baden (CH); Nanesa S.R.L., Roma (IT)

(72) Inventors: Su Zhao, Västerås (SE); Anna Andersson, Västerås (SE); Erik Johansson, Västerås (SE); Gabriele Bartolini, Norcia (IT); Lorenzo Fabbri, Bucine (IT); Emanuele Piciollo, Montevarchi (IT)

(73) Assignees: ABB Schweiz AG, Baden (CH); Nanesa S.R.L., Roma (IT)

(21) Appl. No.: 19/287,925

(22) Filed: Aug. 1, 2025

Related U.S. Application Data
(63) Continuation of application No. PCT/EP2023/052713, filed on Feb. 3, 2023.

(51) Int. Cl. H01H 1/027; C22C 9/00

(52) U.S. Cl. CPC H01H 1/027; C22C 9/00

(57) ABSTRACT

A mechanism comprising a plurality of parts of which a first part comprises a first contact surface and a second part comprises a second contact surface arranged to move in relation to, and in contact with, the first contact surface. The first contact surface is provided by a multilayer coating directly on a surface of a metallic substrate of the first part. The multilayer coating comprises: a base layer arrangement arranged directly on the surface of the substrate; a composite layer arranged on top of the base layer arrangement, the composite layer consisting of particles of a Graphene and Related Materials (GRM) material in a metal matrix; and a metallic top layer arranged directly on top of the composite layer.

### CROSS-REFERENCE TO RELATED APPLICATIONS

The instant application claims priority to International Patent Application No. PCT/EP2023/052713, filed Feb. 3, 2023, which is incorporated herein in its entirety by reference.

### FIELD OF THE DISCLOSURE

The present disclosure generally relates to a mechanism for an electrical switching apparatus.

### BACKGROUND OF THE INVENTION

For electrical switching apparatuses in general, the mechanical drive system relies on lubrication with grease. The grease lowers the friction in the mechanical system as well as minimizes the mechanical wear. However, there are drawbacks such as limited temperature range, degradation of the grease due to particle pollution, and thickening of the grease due to aging or low temperatures, leading to a need for regular maintenance and regreasing. Also, thickening of the grease may lead to an increase in static friction and potentially increased operation time, which could have a large effect on the switching performance. In the worst case, failure of lubrication can lead to complete blockage of the function of the switching device, which could have very large and costly consequences.

### BRIEF SUMMARY OF THE INVENTION

The present disclosure generally describes a mechanism comprising a plurality of parts of which a first part comprises a first contact surface and a second part comprises a second contact surface arranged to move in relation to, and in contact with, the first contact surface, wherein at least one of the first and second contact surfaces is provided by a coating directly on a surface of a metallic substrate of the part to provide dry lubrication.

In one embodiment, an improved, dry (i.e. without use of grease), metal mechanism, e.g., drive and/or actuator, typically for an electrical device, such as a switchgear and/or controlgear, with reduced maintenance need compared to greased mechanisms, is described.

According to an aspect of the present disclosure, there is provided a mechanism comprising a plurality of parts of which a first part comprises a first contact surface and a second part comprises a second contact surface arranged to move in relation to, and in contact with, the first contact surface. The first contact surface is provided by a multilayer (ML) coating on a surface of a metallic substrate of the first part. The ML coating comprises a base layer arrangement arranged on, preferably directly on, the surface of the substrate. The ML coating also comprises a composite layer arranged on top of, preferably directly on top of, the base layer arrangement, the composite layer consisting of particles of a Graphene and Related Materials (GRM) material in a metal matrix. The ML coating also comprises a metallic top layer arranged on top of, preferably directly on top of, the composite layer.

According to another aspect of the present disclosure, there is provided an electrical device comprising an electrical conductor, and an embodiment of the mechanism of the present disclosure.

According to another aspect of the present disclosure, there is provided a method of coating a metallic substrate of a part for a mechanism. The method comprises providing a metal electrolytic solution comprising metal ions and depositing a base layer arrangement on a surface of the substrate by electrodeposition whereby the metal ions are deposited to form a metallic base layer arrangement on, preferably directly on, the surface of the substrate. The method also comprises providing a metal-GRM electrolytic solution comprising GRM particles and metal ions and depositing a composite layer on the base layer arrangement by electrodeposition whereby the GRM particles and metal ions are co-deposited to form a metal-GRM composite layer on top of the base layer arrangement. The methos also comprises, providing a metal electrolytic solution comprising metal ions, and depositing a top layer on the composite layer by electrodeposition whereby the metal ions are deposited to form a metallic top layer on top of, preferably directly on top of, the composite layer.

By use of the Metal-GRM composite layer in or at the first and/or second contact surface(s), dry lubrication is provided, reducing or eliminating the need for lubrication maintenance during the lifetime of the mechanism. Also, by eliminating the need for grease, the lubrication and lubricating effect can be more stable over time and resistant to e.g. high or low temperatures, and dust or other pollutants. The corrosion resistance of the metal part may also be improved by the Metal-GRM composite layer.

By using a multilayer (ML) coating, including a base layer arrangement and a top layer in addition to the metal-GRM (Me-GRRM) composite layer, further advantages are obtained. The base layer arrangement may protect the substrate from corrosion, e.g. oxidation. For instance, a base layer arrangement comprising or consisting of a nickel base layer has been shown to efficiently protect a steel substrate from oxidation, presumably by oxidation of the nickel (forming nickel oxides) instead of the steel. The base layer arrangement, e.g. of nickel, may also improve the adhesion of the composite layer to the substrate (e.g. steel substrate). Similarly, the top layer can protect the composite layer from corrosion, e.g. oxidation. For instance, a nickel top layer has been shown to efficiently protect a copper metal matrix from oxidation, presumably by oxidation of the nickel (forming nickel oxides) instead of the copper. Preferably, the top layer is relatively thin, e.g. having an average thickness of less than 1 micrometer (μm) whereby the top layer may crack upon making contact with another contact surface, exposing the composite layer such that the lubricating properties of the GRM particles may still be exhibited on the contact surface provided by the ML coating, already in the initial stage of use.

### BRIEF DESCRIPTION OF THE SEVERAL VIEWS OF THE DRAWING(S)

FIG. 1 is a schematic circuit diagram of an electrical device in accordance with the present disclosure.

FIG. 2a is a schematic block diagram of an electrical device and drive mechanism thereof in accordance with the present disclosure.

FIG. 2b is a schematic side view of a multilayer coating of a metallic substrate in accordance with the present disclosure.

FIG. 3 is a schematic sectional side view of an electrodeposition bath in accordance with the present disclosure.

FIG. 4 is a schematic flow chart of some embodiments of a method of the present disclosure.

FIG. 5 is an example graph of a standard pin-on-disc reciprocal test at 3 Newton (N) comparing friction of an embodiment of the ML coating of the present invention and a standard greased solution versus a spherical chrome plated steel counter surface, in accordance with the present disclosure.

### DETAILED DESCRIPTION OF THE INVENTION

Embodiments will now be described more fully hereinafter with reference to the accompanying drawings, in which certain embodiments are shown. However, other embodiments in many different forms are possible within the scope of the present disclosure. Rather, the following embodiments are provided by way of example so that this disclosure will be thorough and complete, and will fully convey the scope of the disclosure to those skilled in the art. Like numbers refer to like elements throughout the description.

In accordance with the present invention, a metal-GRM composite is used. Graphene and Related Materials (GRM) include graphene (G), graphene oxide (GO), reduced GO (rGO) and any combination thereof. Thus, when GRM is mentioned herein, any such material is covered by the term. Herein the term graphene (G) is used collectively for carbon atoms in a 2D-honeycomb lattice in the form of mono-layer sheets, bi-layer sheets, few (3-5 layers)-layer sheets, or nano-platelets having an average (e.g. number average) thickness of at most 50 nm, e.g. within the range of 0.3-50 nm. Also, when graphene is discussed herein, it should be understood that some of the graphene may be in the form of graphene oxide (GO) or reduced GO (rGO). Thus, the graphene or GRM may be pure graphene or comprise a mixture of pure graphene and GO and/or rGO. Preferred GRM particles are graphene nanoplatelets (GnP), e.g. having an average (e.g. number average) thickness within the range of 5-50 nm.

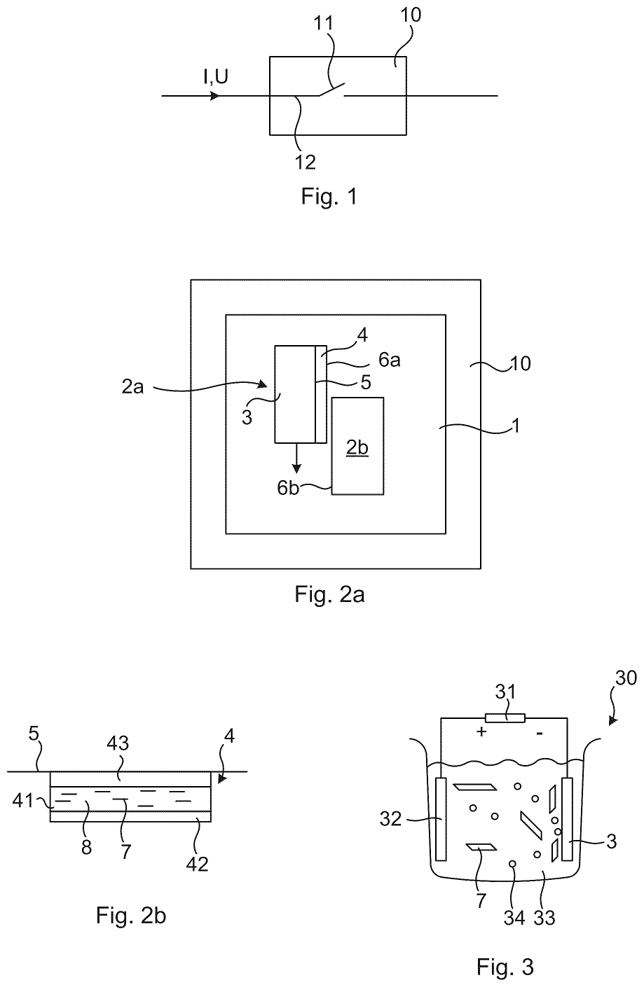

FIG. 1 illustrates an electrical device 10, e.g. a switchgear and/or controlgear, comprising an electrical switch 11 for switching an electrical current I having the voltage U and being conducted by the electrical conductor 12. The electrical device 10 comprises an embodiment of the mechanism 1 of the present disclosure, e.g. an actuator, drive or mechanical joint, for instance a pin joint, as well as the switch 11 (and possibly further switches 11) and the conductor 12 (and possibly further conductors 12). The electrical device 10 may be any switchgear or controlgear configured for breaking or switching a current I by means of the at least one switch 11 and/or conducting the current I by means of the at least one electrical conductor 12. The electrical device 10 may e.g. be configured for breaking or switching a current I having a voltage within the low-voltage range of at most 1 kV, e.g. within the range of 0.01-1 kV, or the medium voltage range, e.g. within the range of 1-52 kV.

FIG. 2a illustrates an electrical device 10, e.g. a switchgear and/or a control gear as discussed above, comprising a mechanical mechanism 1, e.g. a drive and/or an actuator, or a joint which may or may not be part of a drive or actuator, e.g. a pin joint. The mechanism 1 may e.g. be arranged for operating an electrical switch 11. While the mechanism 1 may be comprised in an electrical device, it is typically not supposed to conduct electricity. Thus, the mechanism 1, and any parts 2 thereof, are typically not arranged for conducting the current I, which is instead conducted by a conductor 12. The mechanism 1 may be actuated in any conventional way, e.g. spring, magnetically or pneumatically actuated. The mechanism 1 comprises a plurality of parts 2 which are arranged to move in relation to each other during operation of the mechanism. The mechanism 1 is typically a metal mechanism, implying that at least the substrate 3 of each of the parts 2 is of a metallic material. For two parts 2 which are arranged to move in relation to, and in contact with each other, each comprises a contact surface 6 for making contact with the corresponding contact surface 6 of the other part 2. At least one contact surface 6 of at least one part 2 of the mechanism 1 is provided by the ML coating of the present disclosure which is arranged to act as a dry lubricant, reducing or removing the need for greasing the mechanism 1.

In the embodiment of FIG. 2a, a first part 2a has a first contact surface 6a and a second part 2b has a second contact surface 6b, wherein the first and second contact surfaces 6a and 6b are arranged to move (as indicated by the downward directed arrow in the figure) in relation to and in contact with each other. The first contact surface 6a is provided by the ML coating 4 arranged directly on a surface 5 of a metallic substrate 3 of the first part 2a. Thus, the coating 4 is arranged on the substrate 3, typically on a surface 5 of the substrate such that the coating 4 is in direct contact with the metallic material of the substrate 3. The metallic material of the substrate 3 may e.g. comprise or consist of (typically consist of) steel, e.g. a low carbon steel such as DC01, a high-strength steel such as CrMo steel, or a stainless steel such as SS304. Steel can provide the strength and durability desired for the mechanism 1. In case the part 2 is in the form of, or part of, a spring, the substrate 3 may be made of a spring steel.

The ML coating 4 may form a tribofilm on the contact surface 6a during sliding against the contact surface 6b of the second part 2b. This dry solution gives a coefficient of friction comparable to greased solutions, e.g. in the range 0.15-0.25.

The coating 4 is preferably made by electrodeposition (also called electroplating), but other coating methods such as cold spraying, and laser sintering or oven sintering, are also possible.

FIG. 2b illustrates embodiments of the ML coating 4. The ML coating 4 comprises a composite layer 41 of a GRM particles 7 in a metal matrix 8. The metal of the matrix may conveniently be or comprise (preferably consist of) copper (Cu). The composite layer 41 may have an average thickness of at most 100 μm, e.g. within the range of 10-50 μm, preferably 15-20 μm.

The GRM content in the composite layer 41 may be within the range of 0.1 to 3 or 2 wt %, preferably within the range of 0.3 to 1.5 or 1 wt %, thus being a concentration which provides self-lubricating properties as well as improved wear resistance and resistance high temperatures while not substantially altering the mechanical properties of the matrix 8 metal. Preferably, the composite layer 41 may consist of only GRM and Me, with the GRM particles 7 dispersed within the Me matrix 8.

The GRM 7 is preferably present as few-layer graphene sheets 7 (also called graphene nanoplatelets, GnP, herein), with a preferable thickness within the range of 1-50 nm. The GRM sheets 7 each has a lateral size, herein discussed as a longest diameter, which is several times larger than the thickness, resulting in the platelet form (could also be called a flake or sheet form). In some embodiments, the GRM sheets 7 each has a longest diameter within the range of 5-80 μm.

The metallic top layer 42 of the coating 4 is arranged directly on top of the composite layer 41 and may protect the metal of the matrix 8 in the composite layer 41 from corrosion, specifically oxidation in ambient air but possibly also other corrosion such as chemical (e.g. acid or salt) corrosion. Typically, the top layer 42 consists of metal, a pure metal or a metal alloy, plus any metal oxides resulting from oxidation of the said metal. The metal of the top layer may preferably be pure nickel or a nickel alloy. An advantage with nickel, especially when the metal of the matrix 8 is copper, is that the top layer nickel is oxidated instead of the matrix copper, protecting the composite layer 41 from oxidation. Thus, the top layer 42 may consist of metallic nickel or a nickel alloy and, if some of the nickel has oxidized, nickel oxides.

The top layer 42 is preferably substantially thinner than the composite layer 41. The top layer 42 is preferably thin enough to not significantly reduce the lubricating effect of the composite layer 41 for the contact surface 6a. In some embodiments, the top layer 42 has an average thickness of at most 1 μm, e.g. within the range of 400-700 nm. Any thickness discussed herein may be determined by means of e.g. Scanning Electron Microscope (SEM) such as back-scattered electrons (BSE) SEM.

Similarly, the metallic base layer arrangement 43 of the coating 4 is arranged directly on a surface 5 of the substrate 3 and may protect the metal (e.g. steel) of the substrate from corrosion, specifically oxidation in ambient air but possibly also other corrosion such as chemical (e.g. acid or salt) corrosion. The composite layer 41 is then arranged on top of the base layer arrangement 43, e.g. directly on top of the base layer arrangement or via an intermediate transition or adhesion layer. The base layer arrangement 43 may consist of a single base layer or of a plurality of base layers, e.g. two or three separate base layers, arranged directly on top of each other on the surface 5 of the substrate 3. Typically, each base layer of the base layer arrangement 43 consists of pure metal or a metal alloy, plus any metal oxides resulting from oxidation of the said pure metal. The metal of the base layer may be pure copper or nickel, or an alloy of copper and/or nickel. Preferably the metal of at least one base layer is pure nickel. An advantage with nickel is that the base layer nickel is oxidated instead of the substrate metal. An advantage with copper in the base layer may be improved adhesion to the copper matrix 8 of the composite layer 41. The base layer arrangement 43 may conveniently have an average thickness of at least 1 μm, e.g. within the range of 5-20 μm. A base layer, e.g. a nickel base layer, within the base layer arrangement 43 may have an average thickness within the range of 3-10 μm.

When the substrate 3 is of a low carbon steel, e.g. DC01, the base layer arrangement may conveniently comprise a copper base layer between the substrate and the nickel base layer. An example base layer arrangement 43 comprises or consists of a (pure) copper base layer, preferably arranged directly on the surface 5 of the substrate 3, having an average thickness within the range of 5-10 μm, and a (pure) nickel base layer, preferably arranged directly on the copper base layer, having an average thickness within the range of 3-6 μm (e.g. about 5 μm). On the other hand, e.g. when the substrate 3 is of a high-strength steel (CrMo) or a stainless steel (e.g. SS304), a copper base layer may not be needed or at all convenient. Thus, another example base layer arrangement 43 comprises or consists of a (pure) nickel base layer, preferably arranged directly on the surface 5 of the substrate 3, having an average thickness within the range of 5-10 μm, and preferably no copper base layer.

FIG. 3 illustrates an electrodeposition arrangement or bath 30 for electrodeposition of the layers of the coating 4. For a layer of the base layer arrangement 43, an example Me electrolytic solution 33, typically aqueous, comprises Me ions 34 (but no GRM particles 7). The substrate 3 functions as a cathode and is, as also the corresponding anode 32, connected to a voltage source 31. The anode 32 may e.g. be a copper (sacrificial) anode or an inert anode of mixed oxides. By applying a voltage, by the voltage source 31, between the substrate 3 and the anode 32, the Me ions 34 are deposited (and reduced) on top of the surface 5 of the substrate 3 to form the base layer 43 of metal. The Me ions 34 are typically provided by dissolving a metal salt, e.g. nickel salt or a copper salt such as CuSO₄ and/or CuCl₂ in the electrolytic solution 33. In some embodiments, the metal salt content in the solution 33 is within the range of 50-250 grams per litre (g/L). An example electrolytic solution 33 for the base layer comprises CuSO4 50-300 g/L, CuCl2 20-250 ppm, H2SO4 10-200 g/L.

For the composite layer 41, an example Me-GRM electrolytic solution 33, typically aqueous, comprises GRM particles 7, typically in the form of GnP, and Me ions 34. The substrate 3 functions as a cathode and is, similar as a corresponding anode 32, connected to a voltage source 31. By applying a voltage, by the voltage source 31, between the substrate 3 and the anode 32, the GRM particles 7 and Me ions 34 are co-deposited on top of the base layer 43 to form the composite layer 41. The Me ions 34 are typically provided by dissolving a metal salt, e.g. a copper salt such as CuSO₄ and/or CuCl₂ in the electrolytic solution 33. In some embodiments, the metal salt content in the solution 33 is within the range of 50-250 grams per litre (g/L). An example electrolytic solution 33 for the composite layer 41 comprises CuSO4 50-300 g/L, CuCl2 10-400 ppm, graphene 0.01-10 g/L, dispersing agent 0.01-10 g/L. The GRM content in the solution 33 may preferably be within the range of 0.01-1.5 g/L.

Similarly, as for the base layer, for the top layer 42, an example Me electrolytic solution 33, typically aqueous, comprises Me ions 34 (but no GRM particles 7). The substrate 3 functions as a cathode and is, as also the corresponding anode 32, connected to a voltage source 31. By applying a voltage, by the voltage source 31, between the substrate 3 and the anode 32, the Me ions 34 are deposited (and reduced) on top of the composite layer 41 to form the top layer 42 of metal. Again, the Me ions 34 are typically provided by dissolving a metal salt, e.g. a nickel salt in the electrolytic solution 33. In some embodiments, the metal salt content in the solution 33 is within the range of 50-250 grams per litre (g/L). An example electrolytic solution 33 for the top layer 42 comprises CuSO4 50-300 g/L, CuCl2 20-250 ppm, H2SO4 10-200 g/L.

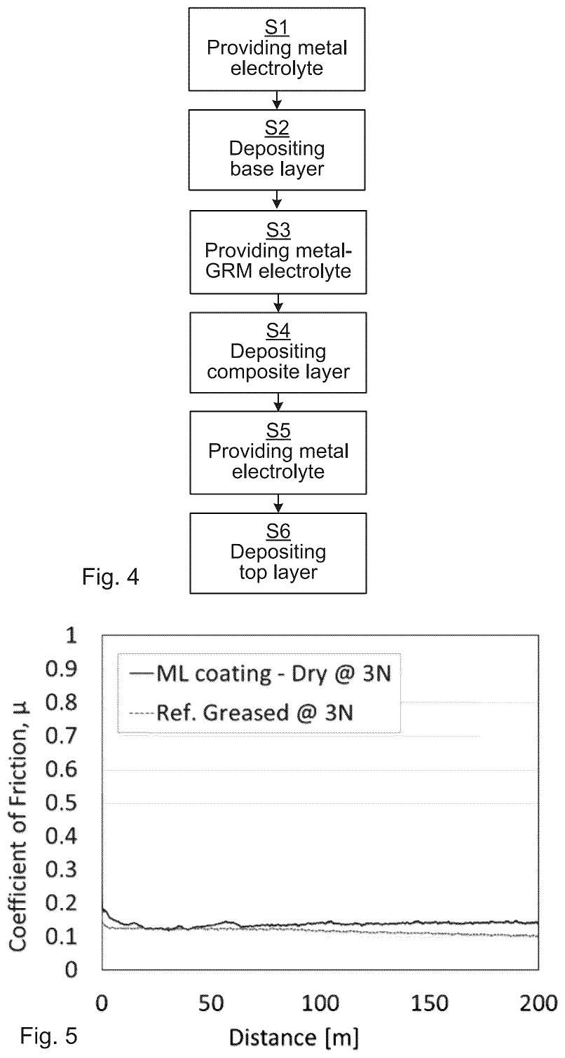

FIG. 4 illustrates some embodiments of a method of coating a metallic substrate 3 of a part 2 of a mechanism 1, e.g. for an electrical device 10. The method comprises, for arranging the base layer arrangement 43 on the substrate 3, providing S1 a metal electrolytic solution 33 comprising metal ions 34, preferably nickel ions or copper ions, and depositing S2 a base layer of the base layer arrangement 43 on, e.g. directly on, the surface 5 of the substrate 3 by electrodeposition whereby the metal ions 34 are deposited (and reduced) to form a metallic base layer on the surface of the substrate.

The method then comprises, for arranging the composite layer 41 on top of the base layer arrangement 43, providing S3 a metal-GRM electrolytic solution 33 comprising GRM particles 7 and metal ions 34, preferably copper ions, and depositing S4 the composite layer 41 on, e.g. directly on, the base layer arrangement 43 by electrodeposition whereby the GRM particles 7 and metal ions 34 are co-deposited to form a metal-GRM composite layer on top of the base layer arrangement.

The method then comprises, for arranging the top layer 42 on top of the composite layer 41, providing S5 a metal electrolytic solution 33 comprising metal ions 34, preferably nickel ions, and depositing S6 the top layer 42 on, preferably directly on, the composite layer 41 by electrodeposition whereby the metal ions 34 are deposited (and reduced) to form a metallic top layer on top of the composite layer.

FIG. 5 shows an example graph of a standard pin-on-disc reciprocal test at 3 Newton (N) comparing friction of an embodiment of the ML coating of the present invention and a standard greased solution. As can be seen, a similarly low friction is obtained by means of the ML coating 4 of the present invention as with conventional grease.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A mechanism, comprising:
a first part having a first contact surface;
a second part having a second contact surface arranged to move in relation to, and in contact with, the first contact surface;
wherein the first contact surface is provided by a multilayer coating on a surface of a metallic substrate of the first part; and
wherein the multilayer coating comprises:
a base layer arrangement arranged on the surface of the metallic substrate of the first part, wherein the base layer arrangement comprises a base layer of nickel or a nickel alloy;
a composite layer arranged on top of the base layer, the composite layer consisting of particles of a graphene material in a metal matrix; and
a metallic top layer arranged on top of the composite layer, wherein the top layer is made of nickel or a nickel alloy.

2. The mechanism of claim 1, wherein the top layer is made of nickel or a nickel alloy.

3. The mechanism of claim 1, wherein the top layer has a thickness between 400 and 700 nm.

4. The mechanism of claim 1, wherein the base layer comprises at least one of a base layer of nickel, a nickel alloy, metallic nickel, nickel oxides, copper, and a copper alloy.

5. The mechanism of claim 1, wherein the base layer has a thickness between 5 and 20 μm.

6. The mechanism of claim 1, wherein the metal matrix is made of copper.

7. The mechanism of claim 1, wherein the graphene content in the composite layer is within a range of 0.1 to 3 wt %.

8. The mechanism of claim 1, wherein the particles are in the form of sheets having a thickness within the range of 0.3-50 nm.

9. The mechanism of claim 8, wherein the sheets are graphene nanoplatelets (GnP) having a thickness between 5 and 50 nm.

10. The mechanism of claim 1, wherein the composite layer has a thickness within a range of 10-50 μm.

11. The mechanism of claim 1, wherein the substrate is made of steel.

12. The mechanism of claim 1, wherein the mechanism is an actuator, drive, mechanical joint, or pin joint, for a switchgear or controlgear, and the first and second parts are not arranged for conducting an electrical current.

13. An electrical device, comprising:
an electrical conductor; and
a mechanism comprising a first part having a first contact surface, and a second part having a second contact surface arranged to move in relation to, and in contact with, the first contact surface;
wherein the first contact surface is provided by a multilayer coating on a surface of a metallic substrate of the first part; and
wherein the multilayer coating comprises a base layer arrangement arranged on the surface of the metallic substrate of the first part; a composite layer arranged on top of the base layer, the composite layer consisting of particles of a Graphene and Related Materials (GRM) material in a metal matrix; and a metallic top layer arranged on top of the composite layer.

14. The electrical device of claim 13, wherein the electrical device is a switchgear and/or controlgear comprising an electrical switch.

15. The electrical device of claim 14, wherein the electrical switch is a circuit breaker or a contactor.

16. A method of producing a mechanism, the method comprising:
for a base layer arrangement, providing a metal electrolytic solution comprising metal ions;
depositing at least a layer of the base layer arrangement on at least a portion of a surface of the substrate by electrodeposition, whereby the metal ions are deposited to form a metallic base layer on the surface of the substrate;
for a composite layer, providing a metal-graphene electrolytic solution comprising graphene particles and metal ions;
depositing the composite layer on the base layer arrangement by electrodeposition whereby the graphene particles and metal ions are co-deposited to form a metal-graphene composite layer on top of the base layer arrangement;
for a top layer, providing a metal electrolytic solution comprising nickel ions; and
depositing the top layer on the composite layer by electrodeposition, whereby the nickel ions are deposited to form a metallic top layer on top of the composite layer.
